(19) United States
(12) Patent Application Publication
(10) Pub. No.: US 2019/0194008 A1
(43) Pub. Date: Jun. 27, 2019

(54) Self-Supporting Funnel

(71) Applicant: Ralph Kline, Reed City, MI (US)

(72) Inventor: Ralph Kline, Reed City, MI (US)

(21) Appl. No.: 16/225,503

(22) Filed: Dec. 19, 2018

Related U.S. Application Data
(60) Provisional application No. 62/608,682, filed on Dec. 21, 2017.

(51) Int. Cl. B67C 11/02

(52) U.S. Cl. CPC B67C 11/02; B67C 2011/027

(57) ABSTRACT

A self-supporting funnel designed to allow a user to use both hands to pour liquids therethrough at a specified angle. The self-supporting funnel includes a conical body having a first end disposed opposite a second end and tapers inward therebetween at a specified angle. The first end has an annular opening with a diameter and is designed to receive liquids therethrough. The second end has an annular opening with a diameter less than the diameter of the first end and is designed to expel liquids therethrough. A spout extends from the second end and includes an aperture therethrough. A stopper is removably secured to a distal end of the spout and also includes an aperture extending therethrough. In this way, a user is able to secure the self-supporting funnel within an aperture and thereby use both hands to pour liquids therethrough at a specified angle.

### CROSS REFERENCE TO RELATED APPLICATIONS

This application claims the benefit of U.S. Provisional Application No. 62/608,682 filed on Dec. 21, 2017. The above identified patent application is herein incorporated by reference in its entirety to provide continuity of disclosure.

### BACKGROUND OF THE INVENTION

The present invention relates to funnels. More specifically, the invention provides a conical body tapering inward from a first end to a second end, with a spout extending from the second end, wherein the spout is configured to removably secure to a stopper which is configured to removably secure to an aperture in a car engine.

Many people often use funnels to pour new cleaning fluids or wiper fluids into their car, or otherwise provide maintenance to their vehicle. However, these funnels require stabilization while pouring liquids through them, or the liquid will spill, wasting money and infuriating the user. Unfortunately, the bottles used to refill the maintenance areas of the car are often large, heavy, and otherwise unwieldly, often leading to spills and wasted product. Although individuals may ask another person to help them pour the liquid, it can sometimes be difficult to find a second person, as additional individuals are not always available. Thus, an improved self-supporting funnel that can efficiently allow s to use both hands to pour liquids therethrough at a specified angle is desired.

### SUMMARY OF THE INVENTION

In view of the foregoing disadvantages inherent in the known types of self-supporting funnels now present in the known art, the present invention provides self-supporting funnel wherein the same can be utilized for providing convenience for the user when desiring to allow a user to use both hands to pour liquids therethrough at a specified angle.

The present system comprises a self-supporting funnel. The self-supporting funnel comprises a conical body having a first end disposed opposite a second end, wherein the first end has an opening configured to receive liquids therethrough and the second end has an opening configured to expel liquids therethrough. The first end includes a diameter greater than a diameter of the second end, such that the conical body tapers inward from the first end to the second end, forming a specified angle. A spout having an aperture therethrough is affixed to the second end and extends away from the conical body. A stopper is removably secured to a distal end of the spout, wherein the stopper includes an aperture extending therethrough. In this way, a user is able to secure the self-supporting funnel within an aperture and thereby use both hands to pour liquids therethrough at a specified angle.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the self-supporting funnel.

FIG. 1B shows a perspective view of an embodiment of the self-supporting funnel with the stopper detached.

FIG. 2 shows a perspective view of another embodiment of the self-supporting funnel.

FIG. 3 shows a perspective view of an embodiment of the self-supporting funnel in use.

### DETAILED DESCRIPTION OF THE INVENTION

Reference is made herein to the attached drawings. Like reference numerals are used throughout the drawings to depict like or similar elements of the self-supporting funnel. The figures are intended for representative purposes only and should not be considered to be limiting in any respect.

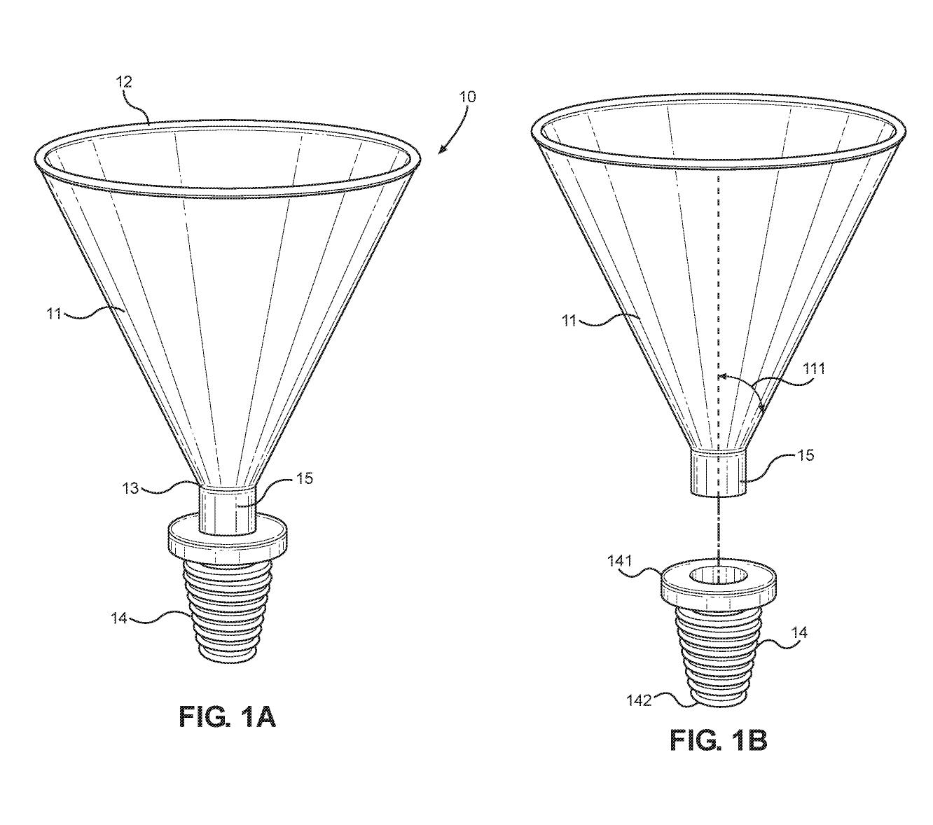

Referring now to FIG. 1A, there is shown a perspective view of an embodiment of the self-supporting funnel. The self-supporting funnel 10 comprises a conical body 11 with a first end 12 disposed opposite a second end 13. The conical body 11 is configured to receive liquid therethrough; as such the first end 12 comprises an opening in communication with an interior of the conical body 11. Additionally, the second 13 comprises an opening in communication with the interior of the conical body 11, such that liquid can flow unimpeded from the first end 12 to the second end 13.

In the illustrated embodiment, the first end 12 and the second end 13 are each annularly shaped, such that the first end 12 has a first diameter and the second end 13 has a second diameter. In the shown embodiment, the first end 12 is at least twice as large as the second end 13, such that the diameter of the first end 12 spans a distance at least two times greater than the diameter of the second end 13. Thus, the first end 12 is appropriately dimensioned to allow the user to easily view the liquid poured into the conical body 11 while the second end 13 is appropriately dimensioned to fit within the desired location. As the first end 12 is greater than the second end 13, the conical body 11 tapers inwardly from the first end 12 towards the second end 13. In this way, liquid is conveyed from the first end 12 to the second end 13 via gravity.

The second end 13 of the conical body 11 further comprises a spout 15 extending away from the second end 13. In the illustrated embodiment, the spout 15 is configured to mirror the shape of the second end 13, such that the spout 15 forms a cylinder extending away from the second end 13 and having an interior volume with a diameter equivalent to the second end 13. In the shown embodiment, the spout 15 has a consistent diameter therealong, such that the interior volume of the spout 15 is continuous along a linear axis and liquid flows unimpeded therethrough.

The self-supporting funnel 10 further comprises a stopper 14 configured to removably secure to the spout 15. As such, the stopper 14 has an aperture which extends therethrough the body of the stopper 14, thereby allowing liquids poured into the conical body 11 to travel through the stopper 14 as well. The stopper 14 is configured to removably secure into an aperture of a car engine. In the shown embodiment, the stopper 14 is composed of rubber. However, in other embodiments, the stopper 14 is composed of any material that includes a friction coefficient greater than one, such that the stopper 14 forms a seal about the aperture the stopper 14 is placed therein. Thus, the stopper 14 prevents liquid from spilling outside the desired aperture. In the illustrated embodiment, the stopper 14 has an outer surface which includes a plurality of flexible flange members disposed thereon to ensure additional sealing while providing additional surface area for a friction fit into the aperture of the engine.

Referring now to FIG. 1B, there is shown a perspective view of an embodiment of the self-supporting funnel with the stopper detached. In the illustrated embodiment, the stopper 14 includes a stopper flange 141 at a first end thereof. The stopper flange 141 is disposed about a perimeter of the first end of the stopper 14, as to allow a user to delineate the break between the stopper 14 and the conical body 11 and provide a grip to remove the stopper 14 therefrom. In the shown embodiment, the stopper flange 141 is distributed consistently about the perimeter of the stopper 14, such that the stopper flange 141 has a consistent width therearound, such that the user may grip the stopper 14 at any angle. In one embodiment, the stopper flange 141 includes a textured outer surface to provide increased friction for a more secure grip. Additionally, the stopper flange 141 includes a planar upper surface, thereby to provide a smooth surface for the user to grip when remove the stopper 14 from the spout 15.

The stopper 14 further includes a lower end 142, wherein the lower end 142 is configured to removably secure within an aperture of an engine of a vehicle. In the illustrated embodiment, the stopper 14 is tapered inward from the stopper flange 141 to the lower end 142, such that an outer body of the stopper 14 has a greater diameter proximate to the stopper flange 141 when compared to the diameter of the outer body of the stopper 14 proximate to the lower end 142. Regardless, in the shown embodiment, the aperture of the stopper 14 extends linearly therethrough, such that the diameter of the aperture wherein the spout 15 is received is equivalent to the lower end 142 providing a constant diameter therethrough independent of the tapering of the outer surface of the stopper 14. The tapered nature of the outer body of the stopper 14 allows the user to easily remove the stopper 14 from the spout 15.

In the illustrated embodiment, the conical body 11 tapers radially from the first end to the second end, such that a consistent funnel angle 111 is measured throughout. In the illustrated embodiment, the funnel angle 111 is configured to measure 45 degrees from a central axis of the conical body, wherein the central axis extends through a center of each of the first opening and the second opening. Thus, the angle thereby allows the liquid poured therein to quickly descend through the conical body 11 and into the desired aperture of the engine and allowing for use when the user is not able to properly grasp or support the conical body 11.

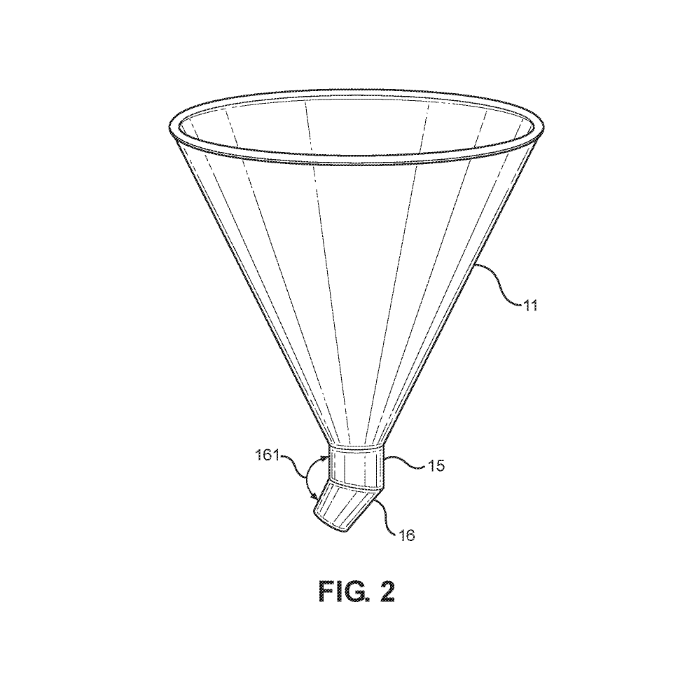

Referring now to FIG. 2, there is shown a perspective view of another embodiment of the self-supporting funnel. In the illustrated embodiment, the self-supporting funnel further comprises a tapered spout 16 having an aperture therethrough. In the shown embodiment, the tapered spout 16 is disposed on the distal end of the spout 15, such that the tapered spout 16 extends away from the spout 15 and the conical body 11. The tapered spout 16 is configured to taper away from the spout. The interior of the tapered spout 16 is configured to taper inwardly, such that the aperture of the tapered spout 16 has a diameter greater than the diameter of the proximal end of the tapered spout 16 affixed to the spout 15. Additionally, the body of the tapered spout 16 tapers outward, such that a first edge of the exterior of the tapered spout 16 forms a tapered spout angle 161 with an adjacent edge of the spout. In the illustrated embodiment, the tapered spout angle 161 is dimensioned at 135-degrees, thereby providing an optimal angle for pouring liquid therethrough.

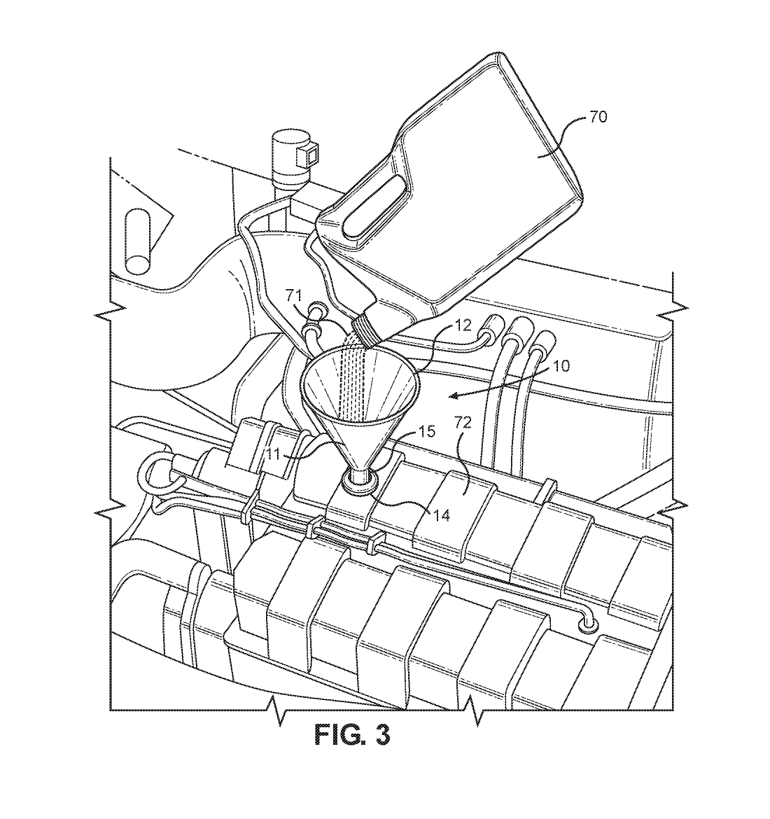

Referring now to FIG. 3, there is shown a perspective view of an embodiment of the self-supporting funnel in use. In operation, the user will threadably secure the stopper 14 into an aperture of the engine 72, wherein the engine aperture the stopper 14 is secured thereto is in communication with the oil tank. The user will then frictionally secure the spout 15 of the funnel 11 into the stopper 14, such that the conical body 11 is in communication with the oil tank. The user is then able to utilize both hands to pour fluid 71 from a bottle 70 into the first end 12 of the conical body 11 without supporting the conical body 11, thereby channeling the fluid 71 into the desired area of the vehicle in a fast and controlled manner. In this way, the self-supporting funnel 10 allows a user to removably secure the device without relying on additional help to support the funnel while in use.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A self-supporting funnel, comprising:
a conical body having a first end disposed opposite a second end;
the first end having an opening configured to receive liquids therethrough;
the second end having an opening configured to expel liquids therethrough;
a spout extending away from the second end, having an aperture extending therethrough;
wherein a diameter of the first end is greater than a diameter of the second end such that the conical body tapers inwardly from the first end to the second end;
a stopper removably secured at a distal end of the spout.

2) The self-supporting funnel of claim 1, wherein the diameter of the first end is at least twice as large as the diameter of the second end.

3) The self-supporting funnel of claim 1, wherein the conical body tapers radially inward from the first end to the second end.

4) The self-supporting funnel of claim 3, wherein the conical body tapers at a 45-degree angle when measured from a central axis.

5) The self-supporting funnel of claim 1, wherein the stopper has an outer surface with a plurality of flexible flange members disposed therearound.

6) The self-supporting funnel of claim 1, wherein the stopper further comprises a stopper flange disposed around a perimeter of a first end of the stopper, wherein the first end of the stopper configured to receive the spout therein.

7) The self-supporting funnel of claim 6, wherein the stopper flange has a consistent width therearound.

8) The self-supporting funnel of claim 1, wherein the spout has a consistent diameter.

9) The self-supporting funnel of claim 8, wherein the spout has a diameter equivalent to the diameter of the second end of the conical body.

10) The self-supporting funnel of claim 1, wherein the spout includes a tapered spout extending therefrom.

11) The self-supporting funnel of claim 10, wherein the tapered spout extends from the spout at a 135-degree angle.
